(19) United States
(12) Patent Application Publication
(10) Pub. No.: US 2004/0164980 A1
(43) Pub. Date: Aug. 26, 2004

(54) Nonlinearity and reset conflicts in pulse width modulated displays

(76) Inventor: Gregory J. Hewlett, Richardson, TX (US)

Correspondence Address: TEXAS INSTRUMENTS INCORPORATED, P O BOX 655474, M/S 3999, DALLAS, TX, 75265

(21) Appl. No.: 10/727,391

(22) Filed: Dec. 4, 2003

Related U.S. Application Data
(60) Provisional application No. 60/430,958, filed on Dec. 4, 2002.

(51) Int. Cl. G06F 17/00; G06T 1/00

(52) U.S. Cl. 345/418

(57) ABSTRACT

One embodiment of the present disclosure provides a display system in which the display period of a conflict bit is skewed. Errors created by the skewing of the conflict bit may occur in one or more compensation bits. The compensation bits typically surround the conflict bit—and possibly the display periods or segments thereof of additional image data bits—in the bit sequence used to display an image data word. The compensation bits may be two segments corresponding to an image data bit, in which the errors imparted to the two segments may completely or partially cancel. The compensation bits may be two segments corresponding to the display periods of different image data bits. When the compensation bits correspond to different image bits additional segments of the different image data bits may occur elsewhere in the bit sequence and completely or partially cancel any errors.

### CROSS-REFERENCE TO RELATED APPLICATIONS

The following patents and/or commonly assigned patent applications are hereby incorporated herein by reference:

| Patent No. | Filing Date | Issue Date | Title |
|---|---|---|---|
| 5,061,049 | Sept. 13, 1990 | Oct. 29, 1991 | Spatial Light Modulator and Method |
| 5,583,688 | Dec. 21, 1993 | Dec. 10, 1996 | Multi-Level Digital Micromirror Device |
| 6,008,785 | Nov. 20, 1997 | Dec. 28, 1999 | Generating Load/Reset Sequences For Spatial |
| | | | Light Modulator |
| 6,201,521 | Sep. 27, 1996 | Mar. 13, 2001 | Divided Reset For Addressing Spatial Light |
| | | | Modulator |
| 09/918,837 | Jul. 31, 2001 | | Display Operation With Inserted Block Clears |
| 10/102,499 | Mar. 19, 2002 | | Control Timing For Spatial Light Modulator |

### TECHNICAL FIELD

This invention relates generally to display systems, more particularly to display systems utilizing pulse width modulation to create intermediate intensity levels.

### BACKGROUND

The image quality of display systems continues to increase. Modern display systems are capable of creating images having a very large number of gray shades. Digital display systems, such as micromirror based displays and some plasma and liquid crystal displays, utilize pulse width modulation to create the appearance of intermediate gray levels when the display device is only capable of creating full intensity levels. Creating a very large number of gray levels using a pulse width modulation based system requires the least significant bits to be very short. This leads to inefficiencies and image artifacts. What is needed is a pulse width modulated display system and method therefor that supports the creation of very short bits without the inefficiencies and artifacts associated with existing systems.

### SUMMARY

Objects and advantages will be obvious, and will in part appear hereinafter and will be accomplished by the present invention which provides a method and system for managing reset conflicts and non-linearity in pulse width modulated displays. One embodiment of the claimed invention provides a method of creating an image. The method comprises operating a display to create a sequence of bit display periods. The bit display periods comprise: at least one conflict bit period skewed with respect to other bit display periods; and at least two compensating bit periods. The compensating bit periods having a bit period such that an error created by skewing occurs during the compensating bits.

Another embodiment of the present invention provides a display comprising: an image data source and a display device. The display device comprising at least one display element operable to form an image pixel corresponding to a plurality of image data bits over a sequence of bit display periods. The bit display periods comprising: at least one conflict bit period skewed with respect to other bit display periods; and at least two compensating bit periods having a bit period such that an error created by the skewing occurs during the compensating bits.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a small portion of a micromirror array of the prior art.

FIG. 2 is an exploded perspective view of a single micromirror element from the micromirror array of FIG. 1.

FIG. 3 is a timeline showing the bit periods for a simple 5-bit monochromatic display period.

FIG. 4 is a timeline showing the bit periods for the monochromatic display period of FIG. 3 with bit splitting.

FIG. 5 is a plan view of a display showing the logical grouping of the display elements in to segments.

FIG. 6 is a reset timeline for a display having seven logical groups of display elements illustrating a reset conflict.

FIG. 7 is a reset timeline for a display having seven logical groups of display elements illustrating skewed reset times to avoid the reset conflict shown in FIG. 6.

FIG. 8 is a timeline for three reset blocks showing the placement of the skewed bit immediately between two display periods of another bit.

FIG. 9 is a timeline for three reset blocks showing the placement of the skewed bit and at least one other bit between two display periods of another bit.

FIG. 10 is a timeline for three reset blocks showing the placement of the skewed bit immediately between the display periods of two bits that appear in opposite order during another portion of the image frame.

FIG. 11 is a timeline for three reset blocks showing the placement of the skewed bit and at least one other bit between the display periods of two bits that appear in opposite order during another portion of the image frame.

FIG. 12 is a schematic view of a micromirror-based projection system that avoids reset conflict according to one embodiment of the present invention.

### DETAILED DESCRIPTION OF THE PREFERRED EMBODIMENTS

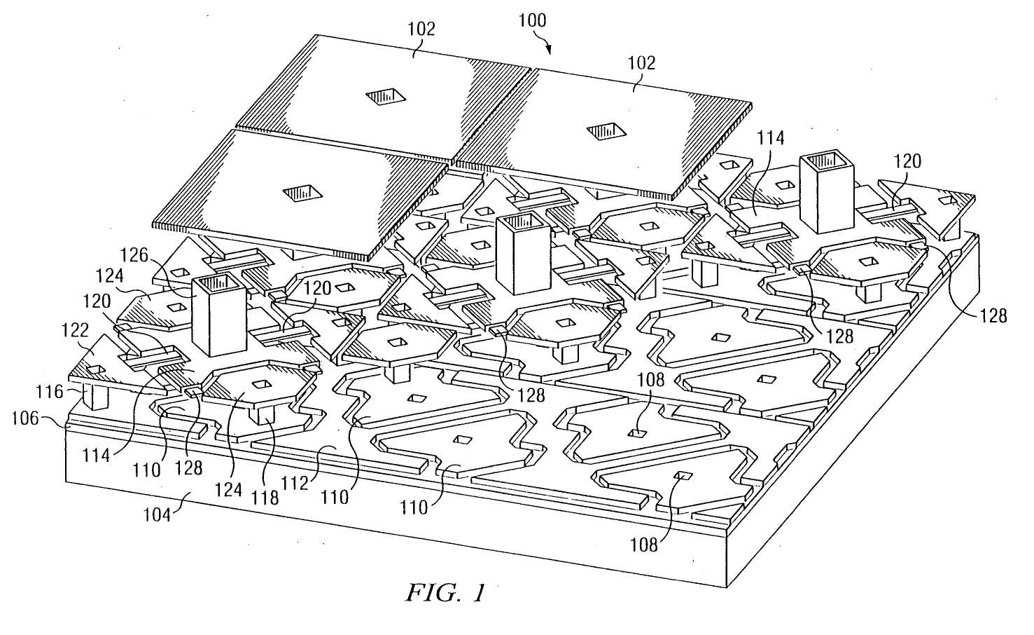

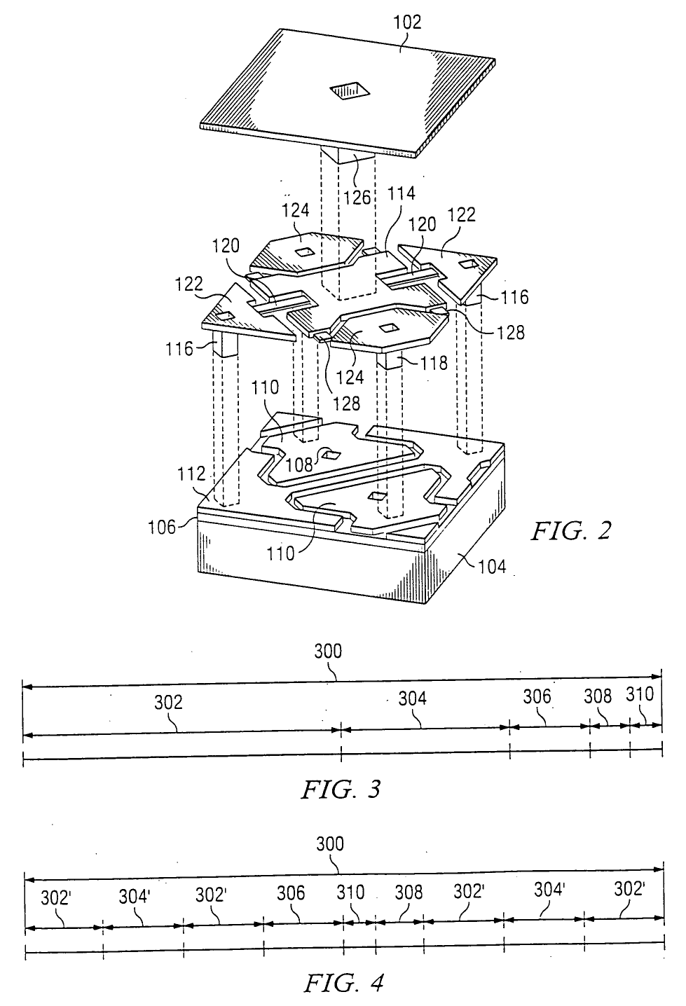

A typical hidden-hinge micromirror 100 is actually an orthogonal array of micromirror cells, or elements. This array often includes more than a thousand rows and columns of micromirrors. FIG. 1 shows a small portion of a micromirror array of the prior art with several mirrors 102 removed to show the underlying mechanical structure of the micromirror array. FIG. 2 is an exploded view of a single micromirror element of the prior art further detailing the relationships between the micromirror structures.

A micromirror is fabricated on a semiconductor, typically silicon, substrate 104. Electrical control circuitry is typically fabricated in or on the surface of the semiconductor substrate 104 using standard integrated circuit process flows. This circuitry typically includes, but is not limited to, a memory cell associated with, and typically underlying, each mirror 102 and digital logic circuits to control the transfer of the digital image data to the underlying memory cells. Voltage driver circuits to drive bias and reset signals to the mirror superstructure may also be fabricated on the micromirror substrate, or may be external to the micromirror. Image processing and formatting logic is also formed in the substrate 104 of some designs. For the purposes of this disclosure, addressing circuitry is considered to include any circuitry, including direct voltage connections and shared memory cells, used to control the direction of rotation of a micromirror.

The silicon substrate 104 and any necessary metal interconnection layers are isolated from the micromirror superstructure by an insulating layer 106 which is typically a deposited silicon dioxide layer on which the micromirror superstructure is formed. Holes, or vias, are opened in the oxide layer to allow electrical connection of the micromirror superstructure with the electronic circuitry formed in the substrate 104.

Address electrodes 110 and a mirror bias connection 112 are formed from a metal layer deposited on the insulating layer 106. Some micromirror designs have separate and distinct landing electrodes which are electrically connected to the mirror bias connection 112. Landing electrodes limit the rotation of the mirror 102 and prevent the rotated mirror 102 or hinge yoke 114 from touching the address electrodes 110, which have a voltage potential relative to the mirror 102. If the mirror 102 contacts the address electrodes 110, the resulting short circuit could fuse the torsion hinges 120 or weld the mirror 102 to the address electrodes 110, in either case ruining the micromirror. Since the same voltage is always applied both to the landing electrodes and the mirrors 102, the mirror bias connection and the landing electrodes are combined in a single structure when possible. The landing electrodes are combined with the mirror bias connection 112 by including regions on the mirror bias/reset connection 112, called landing sites, which mechanically limit the rotation of the mirror 102 by contacting either the mirror 102 or the torsion hinge yoke 114. These landing sites are often coated with a material chosen to reduce the tendency of the mirror 102 and torsion hinge yoke 114 to stick to the landing site.

Hinge support spacervias 116 and upper address electrode spacervias 118, typically extend approximately 1 μm above the address electrodes 110 and mirror bias connections 112. A hinge cap 122 and upper address electrodes 124 are supported by the hinge support spacervias 116 and upper address electrode spacervias 118. The hinge cap 122 anchors the ends of torsion hinges 120. A hinge yoke 114 is formed between and supported by the torsion hinges 120. The hinge yoke 114 is allowed to rotate by twisting the thin torsion hinges 120. A mirror support spacervia 126 is formed on the hinge yoke, and supports a mirror 102 approximately 2 μm above the hinge yoke 114.

Electrostatic attraction between an address electrode 110 and a deflectable rigid member, which in effect form the two plates of an air gap capacitor, is used to rotate the mirror structure. Depending on the design of the micromirror device, the deflectable rigid member is the torsion beam yoke 114, the beam or mirror 102, a beam attached directly to the torsion hinges, or a combination thereof. The upper address electrodes 124 also electrostatically attract the deflectable rigid member.

The force created by the voltage potential is a function of the reciprocal of the distance between the two plates. As the rigid member rotates due to the electrostatic torque, the torsion beam hinges resist deformation with a restoring torque that is an approximately linear function of the angular deflection of the torsion beams. The structure rotates until the restoring torsion beam torque equals the electrostatic torque or until the rotation is mechanically blocked by contact between the rotating structure and a fixed component. Most micromirror devices are operated in a digital mode wherein sufficiently large bias voltages are used to ensure full deflection of the micromirror superstructure.

When operated digitally, each micromirror is fully deflected in either of the two directions about the torsion beam axis. Digital operation uses a relatively large voltage to ensure the mirror is fully deflected. Since it is advantageous to drive the address electrode using standard logic voltage levels, a bias voltage, typically a negative voltage, is applied to the mirror metal layer to increase the voltage difference between the address electrodes and the mirrors. Use of a sufficiently large mirror bias voltage—a voltage above what is termed the collapse voltage of the device—ensures the mirror will deflect to the closest landing electrodes even in the absence of an address voltage. Therefore, by using a large mirror bias voltage, the address voltages need only be large enough to deflect the mirror slightly.

To create an image using the micromirror device, the light source is positioned at an angle equal to twice the angle of rotation so that mirrors rotated toward the light source reflect light in a direction normal to the surface of the micromirror device and into the aperture of a projection lens—creating a bright pixel on the image plane. Mirrors rotated away from the light source reflect light away from the projection lens—leaving the corresponding pixel dark. Intermediate brightness levels are created by pulse width modulation techniques in which the mirror is rapidly and repetitively rotated on and off. The duty cycle of the mirror determines the quantity of light reaching the image plane. The human eye integrates the light pulses and the brain perceives a flicker-free intermediate brightness level.

Full-color images are generated by using three micromirror devices to produce three single-color images, or by sequentially forming three single-color images using a single micromirror device illuminated by a beam of light passing through three color filters mounted on a rotating color wheel.

FIG. 3 is a timeline illustrating the division of an image period 300 for a 5-bit display system into bit periods. The image period 300 of FIG. 3 typically is an image frame period. Alternatively, the image period could be a color frame period in a sequential color display, or a portion of any of such periods. The image period 300 of FIG. 3 is divided into five binary bit periods during each of which one image bit of a 5-bit intensity data word is displayed.

The image period 300 of FIG. 3 includes a first bit display period 302 during which the most significant bit (MSB) of the image data is displayed for a period equal to 16/31 of the entire image period 300. The next significant bit is displayed during period 304 for a duration of 8/31 of the entire image period 300. The next significant bit is displayed during period 306 for a duration of 4/31 of the entire image period 300. Likewise, the next significant bit is displayed during period 308 for a duration equal to 2/31 of the entire image period 300. The least significant bit is displayed during period 310 for a duration equal to 1/31 of the entire image period 300.

Using the simple pulse width modulation scheme of FIG. 3 to create intermediate intensity levels, or halftones, can introduce image artifacts. These artifacts are recognized in the art and are most visible when there is motion in the image or motion of the viewer's eye and when the image includes adjacent image pixels having intensity levels near, and on either side of, the threshold of the most significant intensity bit. The artifacts can be mitigated using a number of techniques. One of the most effective techniques splits the duration of the larger bits into multiple periods and distributes the periods throughout the image period. FIG. 4 illustrates bit splitting and redistribution.

In FIG. 4, the MSB bit display period 302 of FIG. 3 is divided into four periods 302′ and distributed across the image period 300. Likewise, the bit display period of the next significant bit is divided into two periods 304′ and distributed within the image period 300. The bits of less significance are not divided, but are located near the center of the image period 300. The timelines shown in FIGS. 3 and 4 are for illustration only. Most display periods utilize a higher number of bits for each color—typically 8 to 12 bits per color. In display systems having a greater number of image bits, more of the bits are split into multiple periods. For example, an 8-bit system by split the MSB into 16 equal periods, the next significant bit into 8 equal periods, the next significant bit into 4 equal periods, and the next significant bit into 2 periods, each of the bit split periods equal to approximately 1/32 of the single color image period 300.

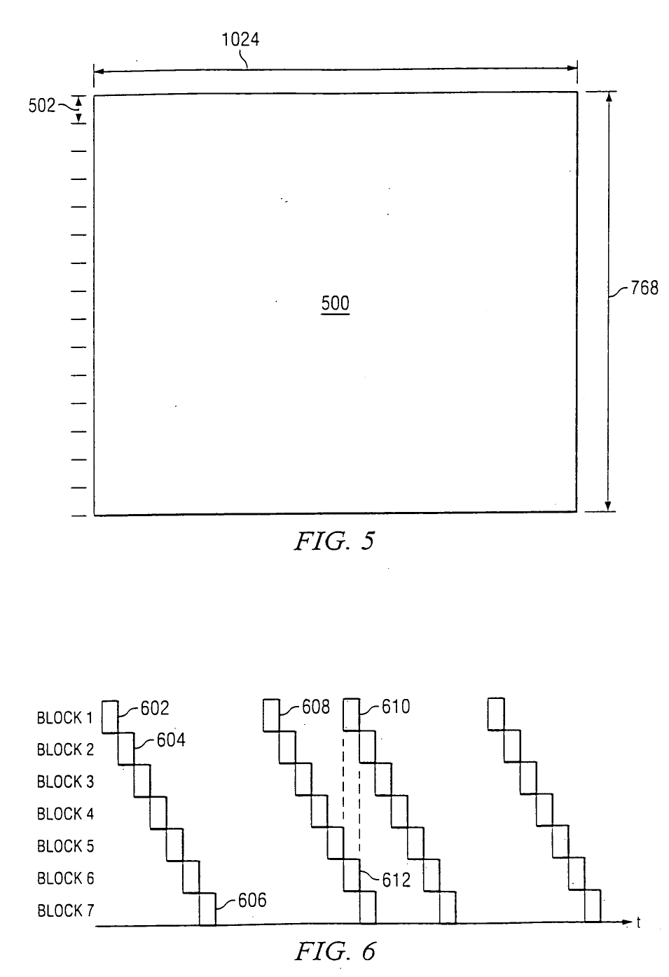

FIG. 5 is a plan view of a display device. The display device 500 of FIG. 5 is a micromirror device. Alternate display devices include plasma displays, liquid crystal displays of various types, emissive devices and spatial light modulators. Not shown in FIG. 5 are the individual display elements of the display device 500. The display device 500 of FIG. 5 is arranged in an orthogonal array of display elements. According to one embodiment, each row of the display device 500 is comprised of 1024 elements while each column is comprised of 768 elements.

In the case of a micromirror device, such as the digital micromirror device (DMD) manufactured by Texas Instruments Incorporated, a memory cell associated with each display element is loaded with image data prior to the element being reset. Because a DMD electrostatically latches the mirror in a fully deflected state, writing new image data to the element will not change the position of the latched mirror.

According to one method of resetting the micromirror device, in order to change the position of the latched mirror, the bias voltage applied to the mirror typically is removed and a reset bias pulse is used to force the mirror to return to the neutral position. After the mirror returns to the neutral position, the mirror bias voltage is reapplied and the mirror assumes the position dictated by the new image data. Other methods of resetting the micromirror element apply a reset pulse and reapply the mirror bias before the mirrors reach the neutral position. Micromirror elements that have retained the same image data—that is, the position of the mirror is not intended to change—are recaptured and returned to the landed state prior to the micromirror element reaching the neutral position.

An eight bit, three color sequential color display system operating at a 60 Hz frame rate has an LSB period of less than 22 μS. The 1024×768 element array of FIG. 5 has 786,432 mirror elements. It is very difficult to write the 98,304 bytes of image data necessary to populate the mirror array in 22 μS given the limited number of I/O paths to the array. One method of reducing the bandwidth required to write to the device involves splitting the device into logical blocks. Many methods of dividing the array into block have been proposed, including diagonal groups and interleaved rows. The most popular method is grouping adjacent rows of the mirror elements. In FIG. 5, the array is divided into 16 equal sized blocks, each comprised of 48 rows of mirrors. Micromirror arrays typically have between 7 and 16 groups, or blocks, of elements.

While each block could be designed to be loaded and reset independently of all other blocks, the blocks typically share the same interface onto the device. Therefore, only one of the blocks can be loaded at a given time. Alternatively, the micromirror device may have two input paths—one to load the top half of the array and one to load the bottom half of the array—which allows two of the logical blocks to be written to at the same time.

Anytime after a logical block of display elements has been loaded with image data, the logical block may be reset. The reset driver circuit used in most DMD display systems is designed to reset only one block of the array at a time. This limits the sequences that may be used to load and reset the device.

FIG. 6 is a timeline showing the reset periods for and array having seven logical blocks of display elements. Not shown in FIG. 6 are the load periods required to input data into the memory cells associated with each block. In FIG. 6, the horizontal axis represents time while the vertical axis corresponds to the vertical dimension of the array. The display elements are assumed to be logically grouped into blocks from the top of the array (block 1) to the bottom of the array (block 7). While this grouping is exemplary of a standard DMD, it is not a limitation of the present invention. As shown in FIG. 6, block 1 is reset during period 602. After reset period 602, block 2 is reset during reset period 604 which may or may not immediately follow reset period 602. The reset sequence continues until block 7 is reset during reset period 606. After block 1 has held its data for an appropriate period, as determined by the bit weight, and during which period new image data has been loaded into the display elements of block 1, block 1 is reset during reset period 608. The display elements in block 1 hold this new state from reset period 608 until reset period 610. Unfortunately, the bit display duration from reset period 608 to reset period 610 is too short to allow all of the blocks of display elements to be reset. As shown in FIG. 6, the third reset period for block 1, reset period 610, occurs simultaneously with the second reset period for block 6, reset period 612. As mentioned above, the reset driver used with most DMDs only allows a single reset group to be reset at a time. In standard micromirror systems with a single input data path and the limitation of only resetting one block at a time, reset conflicts such as shown in FIG. 6 can occur anytime the duration of a bit segment is shorter than the load time of the device. When there are multiple input data paths, or when the ability exists to reset more than one block at a time, the reset conflicts occur whenever the bit display period forces more resets to occur than the device is capable of resetting. For the purposes of this disclosure, bits that are short enough to cause a reset conflict when sequentially loaded and reset will be called conflict bits. Any bit long enough to not cause a reset conflict may be a compensating bit.

One method of avoiding the reset conflict shown in FIG. 6 is to lengthen the display period of the conflicted bit. Lengthening the conflicted bit avoids the reset conflict, but has the undesirable side effect of increasing the effective weight of the bit being lengthened. This increased weight is detectable in the final image produced by the display system. Table 1 illustrates one example in which the least significant bit (LSB) is lengthened to avoid the conflict. As Table 1 illustrates, an increase in the LSB from a desired weight of 1.13 to a weight of 1.242 in order to avoid reset conflicts results in a linearity error of nearly ten percent.

| Bit | Target Weight | Actual Weight | Linearity Error |
|---|---|---|---|
| 0 | 1.130 | 1.242 | 9.94% |
| 1 | 2.000 | 2.000 | |
| 2 | 4.000 | 4.000 | |
| 3 | 8.000 | 8.000 | |
| 4 | 16.000 | 16.000 | |
| 5 | 32.000 | 32.000 | |
| 6 | 64.000 | 64.000 | |
| 7 | 128.000 | 128.000 | |

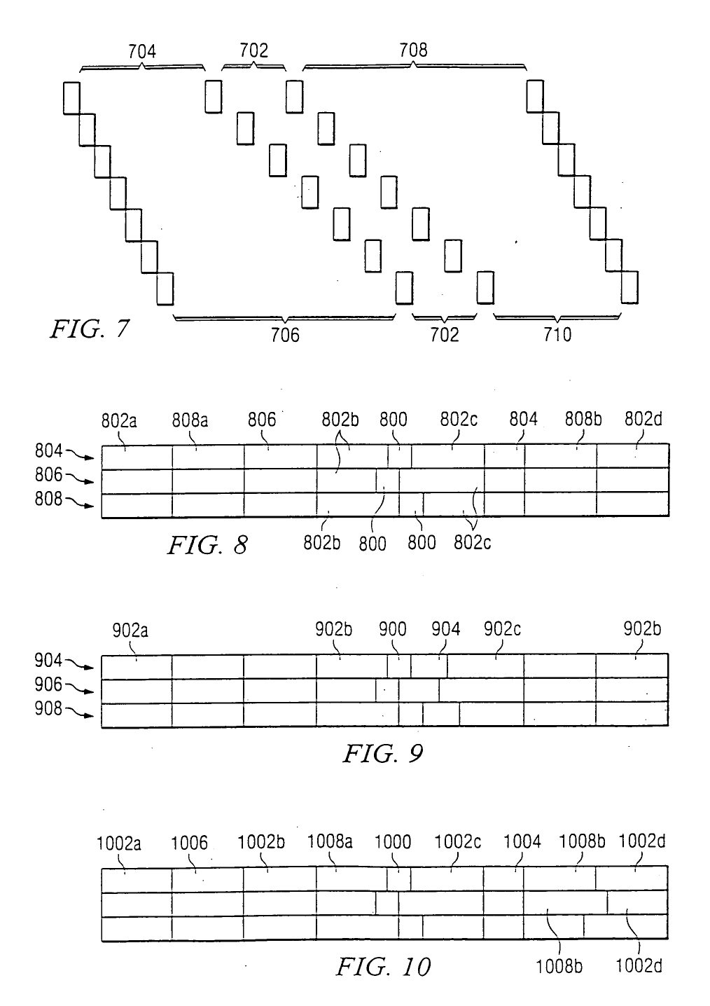

Rather than simply lengthen the conflicted display bit period to avoid the reset conflict, the display period of the conflicted bit can be shifted from one block of display elements to the next, as shown in FIG. 7. Shifting the display period 702 of the previously conflicted bit for each block of the display array avoids conflict with the bit shown in FIG. 7, but also affects other bits during the image period. If all of the bits are shifted, the reset conflict may simply be moved from one bit to another. Increasing the shift or stagger between blocks of the array can also create image artifacts. To avoid creating image artifacts, it is generally desired to limit the delay from the reset period of the first block to the reset period of the last block to no more than 80 mS. Shifting all of the reset blocks may tend to make the generation of the reset sequence more complicated. Because the slope of a line drawn through the reset periods bracketing display period 702 in FIG. 7 changes relative to the reset periods of the unshifted bits, the shifted bit commonly is referred to as a skewed bit.

To simplify the generation of the reset sequence, only the reset periods—and therefore the display periods—of the conflicted bit are staggered or skewed. In FIG. 7, the bit displayed during period 702, typically the LSB, is skewed from the first block to the last block and all reset conflicts are avoided. At the same time, the display period of the bits displayed immediately before and after the skewed bit is changed.

The display periods shown in FIG. 7 are preferable to the scenario in which the LSB is lengthened to avoid reset conflicts. This is because the display periods on either side of the LSB, or another of the least significant half of the bits, are larger bits and the same error period is much less significant relative to the larger bits. Not only is the illumination error a smaller fraction of the desired pixel intensity created by the display element, the error is introduced to a brighter pixel—since one of the MSBs is illuminated—and the human eye is much less sensitive to small changes in illumination in brighter images compared to darker images.

Table 2 illustrates the error introduced in one exemplary display system by skewing one of the bits of lesser significance to avoid reset conflicts. In Table 2, the most significant bit, bit 7, precedes the LSB display period 702. The MSB display period 704 for block 1 is shortened due to the skewed LSB display period 702 from a desired weight duration of 128.000 to 125.828, an error of 1.70%. The next significant bit, bit 6, follows the LSB display period 702 as shown by display period 708. Display period 708 is lengthened from a desired weight duration of 64.000 to a realized weight of 66.172, an error of 3.39%. The effect is the opposite on block 7, the last block, with the display period 706 of the MSB being lengthened 1.21% and the display period 710 of the next MSB shortened 2.42%.

| | | Actual | | | |
|---|---|---|---|---|---|
| | Target | Wt. | Linearity | Actual Wt. | Linearity |
| Bit | Weight | Block 1 | Error Block 1 | Block 8 | Error Block 8 |
| 0 | 1.130 | 1.130 | | 1.130 | |
| 1 | 2.000 | 2.000 | | 2.000 | |
| 2 | 4.000 | 4.000 | | 4.000 | |
| 3 | 8.000 | 8.000 | | 8.000 | |
| 4 | 16.000 | 16.000 | | 16.000 | |
| 5 | 32.000 | 32.000 | | 32.000 | |
| 6 | 64.000 | 66.172 | 3.39% | 62.449 | 2.42% |
| 7 | 128.000 | 125.828 | 1.70% | 129.551 | 1.21% |

The skew illustrated in FIG. 7 affects the top and bottom of the display in an opposite manner. By keeping the blocks separated such that adjacent blocks have nearly the same non-linearity, the possibility of the skewing creating noticeable artifacts is minimized. Likewise, no non-linearity is introduced into the center section of the display, block 4.

The relative timing of the display and reset periods from one block of elements to the next may be altered without departing from the teachings of this invention. Specifically, the timing shown for any block of display elements may interchanged with the timing shown for any other block of display elements. The timing relationship shown in FIGS. 6 and 7, in which the loading and resetting of the display groups proceeds sequentially from the top block in the mirror array to the bottom block in the array has advantages. One advantage is that the timing of the reset is easier to illustrate and possibly to implement. Another advantage is that each block of display elements is reset very close in time to the adjacent blocks. Resetting adjacent blocks of display elements at nearly the same time minimizes the chance of the viewer detecting artifacts caused by operating the display in reset blocks.

Alternatively, the center block, block 4 of FIG. 6, could be reset first, followed alternately by those above and below the center, block 3, block 6, block 2, block 7, and block 8. Another possibility is to reset the first block first, followed by block 7, block 2, block 6, block 3, block 5, and block 4.

FIG. 8 shows three timelines for reset blocks of a five bit per color display system. Unlike the prior examples, the three timelines 804, 806, 808 of FIG. 8 are intended to show either three different reset blocks, or the same reset block with different display periods. In FIG. 8, the LSB 800, which is a conflict bit, is sandwiched between two of the bit segments 802b, 802c of the MSB. The first timeline 804 of FIG. 8 does not skew the conflict bit 800, and all of the bit segments retain their basic binary weighting. The second timeline 806 of FIG. 8 skews the conflict bit 800 toward the beginning of the sequence. The first compensation segment 802b is shortened while the second compensation bit 802c is lengthened. The effect of the changes to 802b and 802c cancel out, leaving the total duration of the compensation bit 802 unchanged. Likewise, the third timeline 808 of FIG. 8 skews the conflict bit 800 toward the end of the sequence. The first compensation segment 802b is lengthened while the second compensation bit 802c is shortened. The effect of the changes to 802b and 802c cancel out, leaving the total duration of the compensation bit 802 unchanged.

FIG. 9 shows three timelines for reset blocks of a five bit per color display system. Like FIG. 8, the three timelines 904, 906, 908 of FIG. 9 are intended to show either three different reset blocks, or the same reset block with different display periods. In FIG. 9, the LSB 900, which is a conflict bit, along with the next LSB 904, is sandwiched between two of the bit segments 902b, 902c of the MSB. The first timeline 904 of FIG. 9 does not skew the conflict bit 900, and all of the bit segments retain their basic binary weighting. The second timeline 906 of FIG. 9 skews the conflict bit 900 toward the beginning of the sequence. The next LSB 904 is shifted over with the conflict bit, but the duration of the next LSB 904 is unchanged. The first compensation segment 902b is shortened while the second compensation bit 902c is lengthened. The effect of the changes to 902b and 902c cancel out, leaving the total duration of the compensation bit 902 unchanged. Likewise, the third timeline 908 of FIG. 9 skews the conflict bit 900 toward the end of the sequence, shifting the next LSB 904 with it. The first compensation segment 902b is lengthened while the second compensation bit 902c is shortened. The effect of the changes to 902b and 902c cancel out, leaving the total duration of the compensation bit 902 unchanged. In FIG. 9, any number of additional bits are sandwiched between the compensating bits.

FIG. 10 shows three timelines for reset blocks of a five bit per color display system. The three timelines 1004, 1006, 1008 of FIG. 10 are intended to show either three different reset blocks, or the same reset block with different display periods. In FIG. 10, the LSB 1000, which is a conflict bit is sandwiched between two of the bit segments 1008a, 1002c of the MSB 1002 and next MSB 1008. The first timeline 1004 of FIG. 10 does not skew the conflict bit 1000, and all of the bit segments retain their basic binary weighting. The second timeline 1006 of FIG. 10 skews the conflict bit 1000 toward the beginning of the sequence. The first compensation segment 1008a is shortened while the second compensation bit 1002c is lengthened. Later in the timeline, additional bit segments 1008b and 1002d of the MSB 1002 and next MSB 1008 are adjacent each other, but in opposite order. The second bit segment of the next MSB 1008 is shortened and the fourth bit segment 1002d of the MSB is lengthened. The effect of the changes to 1002b and 1002d cancel out, and the changes to 1008a and 1008b cancel out, leaving the total duration of the compensation bits 1002 and 1008 unchanged. Likewise, the third timeline 1008 of FIG. 10 skews the conflict bit 1000 toward the end of the sequence. Similar but opposite changes to the duration of bit segments 1008a, 1008b, 1002b and 1002d occur to compensate for the shift.

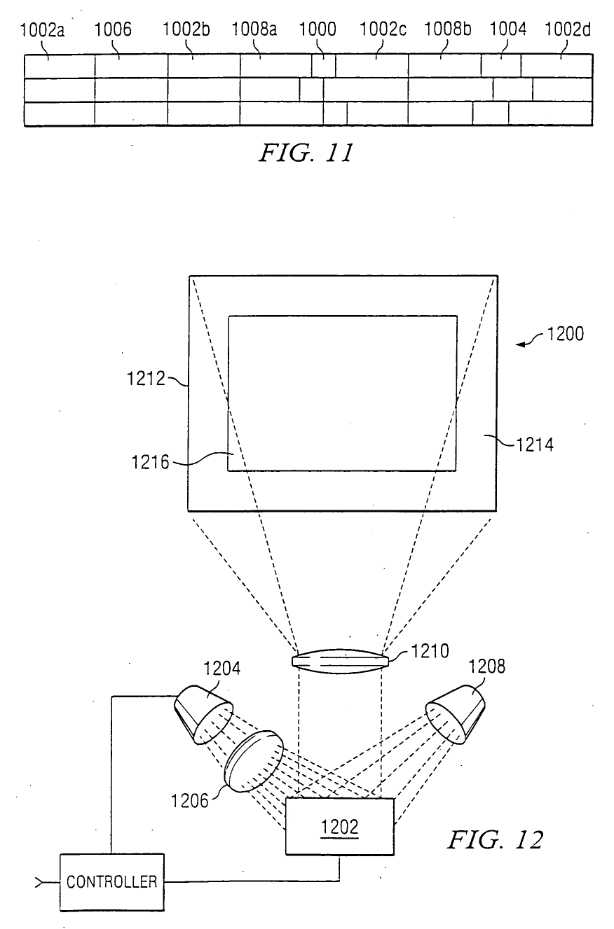

FIG. 11 is a set of timelines similar to those shown in FIG. 10. In FIG. 11, an additional bit 1004, in this case the next LSB, is sandwiched between the compensation bits 1008b, 1002d at the end of the image period. As discussed above, more than one bit may be sandwiched between the compensating bits, or between the conflict bit and one or more of the compensating bits.

FIG. 12 is a schematic view of an image projection system 1200 driving a micromirror 1202 with an improved PWM sequence according to the present invention. In FIG. 12, light from light source 1204 is focused on the improved micromirror 1202 by lens 1206. Although shown as a single lens, lens 1206 is typically a group of lenses and mirrors which together focus and direct light from the light source 1204 onto the surface of the micromirror device 1202. Image data and control signals from controller 1214 cause some mirrors to rotate to an on position and others to rotate to an off position. Mirrors on the micromirror device that are rotated to an off position reflect light to a light trap 1208 while mirrors rotated to an on position reflect light to projection lens 1210, which is shown as a single lens for simplicity. Projection lens 1210 focuses the light modulated by the micromirror device 1202 onto an image plane or screen 1212.

Thus, although there has been disclosed to this point a particular embodiment for a display system having skewed conflict bits and a method therefore, it is not intended that such specific references be considered as limitations upon the scope of this invention except insofar as set forth in the following claims. Furthermore, having described the invention in connection with certain specific embodiments thereof, it is to be understood that further modifications may now suggest themselves to those skilled in the art, it is intended to cover all such modifications as fall within the scope of the appended claims. In the following claims, only elements denoted by the words “means for” are intended to be interpreted as means plus function claims under 35 U.S.C. § 112, paragraph six.

What is claimed is:

1. A method of creating an image, the method comprising:
operating a display to create a sequence of bit display periods, said bit display periods comprising:
at least one conflict bit period skewed with respect to other said bit display periods; and
at least two compensating bit periods having a bit period such that an error created by said skewing occurs during said compensating bits.

2. The method of claim 1 in which said bit period of a first of said at least two compensating bit periods is shortened and said bit period of a second of said at least two compensating bit periods is lengthened.

3. The method of claim 1 in which said bit period of a first of said at least two compensating bit periods is lengthened and said bit period of a second of said at least two compensating bit periods is shortened.

4. The method of claim 1 in which a first and a second of said at least two compensating bit periods are segments of the same image bit.

5. The method of claim 1 in which said bit periods of a first and a second of said at least two compensating bit periods are temporally adjacent said at least one conflict bit period.

6. The method of claim 1 in which said bit periods of a first and a second of said at least two compensating bit periods are temporally adjacent a combination of said at least one conflict bit period and at least one other bit period.

7. The method of claim 1 in which said bit period of a first of said at least two compensating bit periods occurs prior to said at least one conflict bit period and a second of said at least two compensating bit periods occurs following said at least one conflict bit period.

8. The method of claim 7 in which said first compensating bit period corresponds to a first image bit and a second compensating bit period corresponds to a second image bit.

9. The method of claim 8 comprising displaying another bit segment corresponding to said first image bit and another bit segment corresponding to said second image bit in said sequence of bit display periods such that said two another bit segments compensate for said error created by said skewing.

10. The method of claim 9 displaying at least one other image bit between said another bit segment corresponding to said first image bit and said another bit corresponding to said second image bit.

11. A display comprising:
an image data source providing a plurality of image data bits; and
a display device comprising at least one display element operable to form an image pixel corresponding to a plurality of image data bits over a sequence of bit display periods, said bit display periods comprising:
at least one conflict bit period skewed with respect to other said bit display periods; and
at least two compensating bit periods having a bit period such that an error created by said skewing occurs during said compensating bits.

12. The display of claim 11 in which said bit period of a first of said at least two compensating bit periods is shortened and said bit period of a second of said at least two compensating bit periods is lengthened.

13. The display of claim 11 in which said bit period of a first of said at least two compensating bit periods is lengthened and said bit period of a second of said at least two compensating bit periods is shortened.

14. The display of claim 11 in which a first and a second of said at least two compensating bit periods are segments of the same image bit.

15. The display of claim 11 in which said bit periods of a first and a second of said at least two compensating bit periods are temporally adjacent said at least one conflict bit period.

16. The display of claim 11 in which said bit periods of a first and a second of said at least two compensating bit periods are temporally adjacent a combination of said at least one conflict bit period and at least one other bit period.

17. The display of claim 11 in which said bit period of a first of said at least two compensating bit periods occurs prior to said at least one conflict bit period and a second of said at least two compensating bit periods occurs following said at least one conflict bit period.

18. The display of claim 17 in which said first compensating bit period corresponds to a first image bit and a second compensating bit period corresponds to a second image bit.

19. The display of claim 18 comprising displaying another bit segment corresponding to said first image bit and another bit segment corresponding to said second image bit in said sequence of bit display periods such that said two another bit segments compensate for said error created by said skewing.

20. The display of claim 19 displaying at least one other image bit between said another bit segment corresponding to said first image bit and said another bit corresponding to said second image bit.
